(19) United States
(12) Patent Application Publication
(10) Pub. No.: US 2003/0134661 A1
(43) Pub. Date: Jul. 17, 2003

(54) Telephony device with data repeater

(76) Inventors: Clarence Charles Rudd, Noblesville, IN (US); Scott Alan Griepentrog, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/134,163

(22) Filed: Apr. 26, 2002

Related U.S. Application Data
(60) Provisional application No. 60/347,836, filed on Jan. 15, 2002.

(51) Int. Cl. H04M 1/00; H04B 1/38

(52) U.S. Cl. 455/557

(57) ABSTRACT

A telephony device (10₁) communicates data between an external communications device (11₁), such as a laptop computer or Personal Data Assistant, and a communications network (12) via a wireless link while the telephony device carries a telephone call between the network and a telephone (20, 28). A control unit (22, 24) within the telephony device multiplexes data received from the external data communication device via a wireless data communications port for communication via an interface circuit (16, 16₁) to the communications network during the call. Further, the control unit de-multiplexes data received from the network via the interface circuit for communication to the external data communications device over the wireless link during the call.

### CROSS REFERENCE TO RELATED APPLICATIONS

This application claims priority under 35 U.S.C. 119(e) to U.S. Provisional Patent Application Serial No. 60/347836, filed Jan. 10, 2002, the teachings of which are incorporated herein.

### FIELD OF THE INVENTION

This invention relates to telephony devices having the ability to communicate data.

### BACKGROUND OF THE INVENTION

Presently, different types of data communications devices, such as lap top computers and Personal Data Assistant devices (PDAs), incorporate an infrared data communications port for transmitting data to, and receiving data from a device that has a similar type infrared data communications port. Some computer peripheral devices, such as printers, also have an infrared data communications port for receiving infrared signals from a lap top computer or PDA to allow wireless receipt of data by such a peripheral device. While different protocols exist to facilitate communication of data via infrared signals, the IrDA protocol established by the Infrared Data Association, an industry-based standards body, has achieved widespread acceptance as the infrared data communications protocol of choice for many manufacturers of data communications devices and peripherals.

Providing a data communication device such as a laptop computer or PDA with an infrared data communication port allows a user to accomplish data exchange with a data communication device or peripheral device that likewise has an infrared data communications port without the need for any cable linking the devices. Indeed, the user need only position his/her data communication device generally within the line of sight of the recipient device to send data thereto and to receive data therefrom via infrared beams.

Heretofore, users of data communications devices have lacked the ability to easily exchange stored in their data communication devices while engaged in a telephone call. For example when a first party to a call seeks information from second party to a call who has such information stored on a PDA, the second party will typically need to manually read the information to the first party, a tedious process fraught with error.

Thus, there is a need for a mechanism that allows the parties to a telephone call to readily exchange data between the parties' data communications devices in the course of the call.

### BRIEF SUMMARY OF THE INVENTION

Briefly, in accordance with a preferred embodiment, a telephony device communicates data between an external data communications device and a telecommunications network over a wireless link while simultaneously carrying a telephone call. The telephony device includes a line interface circuit for connecting the telephony device to a communications network. A wireless communications data port on the telephony device serves to receive data from, and to send data to an external data communications device, such as a lap top computer or Personal Data assistant, having a compatible wireless data communications port. A control unit in the telephony device serves to multiplex data received at the wireless data communications port from the external data communications device for communication via the line interface unit to the telecommunications network during course of the telephone call carried by the telephony device. The control unit likewise serves to demultiplex data received from the telecommunications network via the line interface circuit for transmission through the wireless data communications port to the external data communication device during the telephone call carried by the telephony device.

The telephony device in accordance with the present principles advantageously permits telephone callers to exchange data between their external data communications devices during a telephone call.

### BRIEF SUMMARY OF THE DRAWINGS

FIG. 1 illustrates a first embodiment of a telephony device in accordance with present principles for allowing a party to a telephone call to send data from, and receive data at a personal data communications device over a wireless link during the course of a call carried by the telephony device;

FIG. 2 illustrates a second embodiment of a telephony device in accordance with present principles for allowing a party to a telephone call to send data from, and receive data at a personal data communications device over a wireless link during the course of a call carried by the telephony device; and

FIG. 3 illustrates a third embodiment of telephony device in accordance with present principles for allowing a party to a telephone call to send data from, and receive data at a personal data communications device over a wireless link during the course of a call carried by the telephony device.

### DETAILED DESCRIPTION

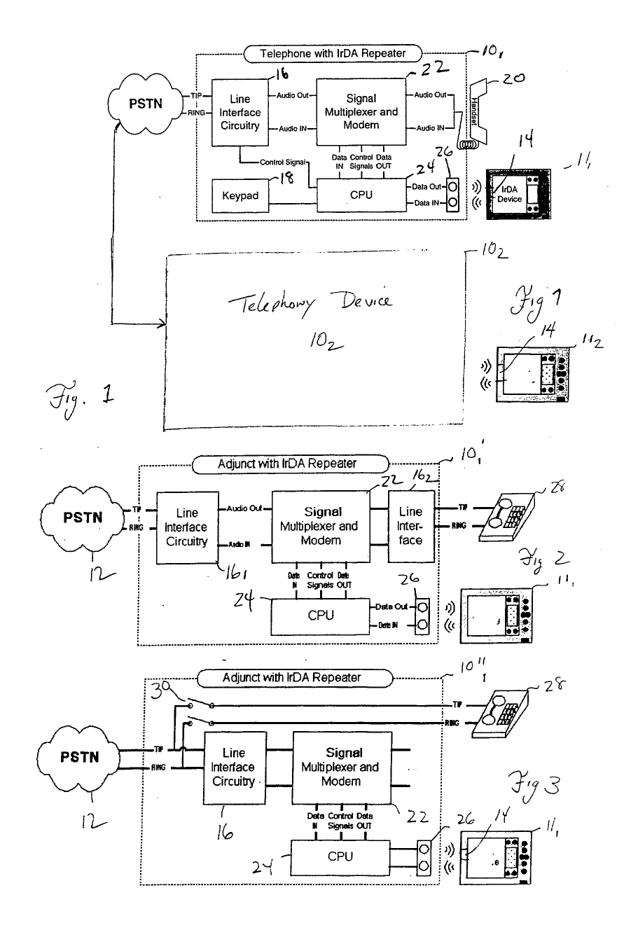

FIG. 1 illustrates a pair of telephony devices 10₁ and 10₂ in accordance with a first illustrative embodiment of the present principles. As discussed hereinafter, each of the telephony devices 10₁ and 10₂ advantageously possesses the capability of transmitting data from, and receiving data at, a corresponding one of a pair of a external data communications devices 11₁ and 11₁ over a wireless link during the course of a telephone call between the telephony devices carried across a communications network 12. In the illustrative embodiment of FIG. 1, the telecommunications network 12 takes the form of the Public Switched Telecommunications Network (PSTN) but could include a wireless network, one or more data networks (not shown), or a combination of one or more data networks and the PSTN. In FIG. 1, each of the external data communications devices 11₁ and 11₂ can take the form of laptop computer, Personal Data Assistant (PDA) or any other type of device that has the ability to send and receive data though a wireless data communications port 14 which illustratively takes the form of an infrared data port. Data communicated via the infrared data communications port 14 on each of the external data communications devices 11₁ and 11₂ can utilize any one of several well-known protocols such as the IrDA protocol.

The telephony devices 10₁ and 10₂ share the same structure so only the details of the telephony device 10₁ will be described. The telephony device 10₁ of FIG. 1 includes a line interface circuit 16 of a well-known design for providing a tip-ring interface to the PSTN 12 to enable the transmission of call audio to, and the receipt of call audio from the PSTN. A signal multiplexer and modem 22 provides a call audio connection between the line interface circuit 16 and a telephone handset 20 so that the handset can send call audio to and receive call audio from the PSTN 12. In addition, the signal multiplexer and modem 22 enjoys a connection to a central processing unit (CPU) 24 coupled to a wireless data communications port 26 in communication with the data communications port 14 in the external data communications device 11₁. A telephone keypad 18 supplies Dual-Tone Multi-Frequency (DTMF) signals to CPU 24 the to enable the user of the telephony device 10₁ to dial a telephone number associated with at least one called party (i.e., the party associated with the device 10₂) to set up a call with that party.

Not shown in FIG. 1 is a switch actuated by the handset 20 that couples the line interface unit 16 to the PSTN 12 to maintain the telephony device “off hook” while the handset 20 is placed in a cradle on the telephony device. The CPU 24 has a control line connection to the line interface circuit 16 to monitor when the telephony device 10₁ goes “off hook” which occurs when the caller lifts the handset to place a call.

As described in greater detail hereinafter, the CPU 24 processes data received at the wireless communications data port 26 from the external data communications device 11₁ and provides such processed data to the signal multiplexer and modem 22. In turn, the signal multiplexer and modem 22 multiplexes such data onto the call audio connection during a telephone call carried by the telephony device 10₁ for receipt by the line interface circuit 16. In turn, the line interface circuit 16 transmits the data multiplexed on the call audio through the PSTN 12 for receipt at the telephony device 10₂. Just as the telephony device 10₁ communicates data in this manner to the telephony device 10₂, the telephony device likewise communicates data to the telephony device 10₁ from the external data communications device 11₂. Upon receipt of such data from the telephony device 10₂, the signal multiplexer and modem 22 within the telephony device 10₁ de-multiplexes the data for processing by the central processing unit 24 and transmission through the wireless data communications port 26 to the external data communications device 11₁.

Data transfer between the external data communications devices 11₁ and 11₂ during the course of a telephone call carried by the telephony devices 10₁ and 10₂ can occur in different ways. After initiation of a telephone call from one of the telephony devices 10₁ and 10₂ to the other, one of the parties to the call can seek to send data from his/her external data communications device to the external data communications device of the other party. The party seeking to send the data (“the sending party”) initiates such data communication by entering an appropriate command to the sending party's external data communication device. In response, the sending party's external data communication device commences data transmission for receipt by the sending party's telephony device. Upon the receipt of the transmitted data at the sending party's telephony device, the central processing unit 24 in the sending party's telephony devices processes the data for receipt at the signal multiplexer and modem 22.

During data transmission between the external data communications devices 11₁ and 11₂, the signal multiplexer and modem 22 can mute (interrupt) the audio communications to and from the handset 20, thereby allowing the data transmission between the external data communications devices 11₁ and 11₂ to occur at a relatively high speed. Alternatively, the signal multiplexer and modem 22 need not mute the audio but can burst short amounts of data during gaps of silence in the call audio. Thus, conversation between the calling and called parties can still occur, but the time required to complete data transfer will increase. Rather than transfer the data during the gaps of silence, data transfer could occur by modulating the data out of band from the normal conversational audio. Again, the data transfer will occur more slowly than if the call audio were muted. Indeed, the signal multiplexer and modem 22 signal could multiplex the data at a low amplitude simultaneously with call audio signal, so that the parties to the call will hear the modem signal, but not at such a volume as to interfere with the telephone conversation. Data transfer will occur more slowly than during intervals while the call audio is muted. However, the structure of the signal multiplexer and modem 22 necessary for such simultaneous data and call audio transmission is typically less expensive than the structure needed to mute the call audio during data transmission.

In addition to the transmission techniques described above, other techniques are also possible. For example, during data transmission, an audible signal with an inverted matching carrier could be placed on the output line to the handset 20 to eliminate most of the data signal heard by the person. During data transfer, it can also be desirable to provide the parties to the call with call audio that corresponds with the transferred data. To that end, the CPU 24 in each telephony device, such as the central processing unit 24 in the telephony device 10₁ of FIG. 1 could perform text-to-speech conversion of data received from, or sent to the associated external data communications device associated with the telephony device, such as the device 11₁.

The telephony device 10₁ described above serves to multiplex data to and from an external data communications device, such as device 11₁, in connection with analog telephony service, i.e., Plain Old Telephone Service (POTS) offered by the PSTN 14. However, the telephony device 10₁ could readily serve to digitally multiplex voice and data in connection with a packet call, such as in connection with Voice over Internet Protocol (VOIP) telephony, Integrated Services Digital Network (ISDN) telephony, Voice over Digital Subscriber Line (VODSL) telephony or Voice over Ethernet (VoE) telephony. To effect such digital telephony service, the CPU 24 within the telephony device 10₁ would operate as previously described to process the data transmitted to and received from the data communications port 26. Likewise, the signal multiplexer and modem 22 would serve to for multiplex data onto and off of the call audio connection to the line interface circuit 16. In the embodiment where the telephony device 10₁ comprises a packet telephone, the line interface unit 16 would typically include a codec (not shown) for packetizing outgoing call audio and multiplexed data into packets for transmission to a receiving packet telephony device and for de-packetizing the incoming packets into call audio and data. The data obtained by such de-packetizing is demultiplexed by the signal multiplexer and modem 22 for processing by the central processing 24 unit and transmission via by the wireless data communications port 26 to the associated external data communications device 11₁.

Rather than multiplex data on the call audio for packetizing at the line interface unit 16 of the telephony device 10₁, the CPU 24 could process incoming data received at the wireless data communications port 26 in packet form and forward such packets directly to the line interface unit 16, obviating the need for the signal multiplexer and modem 22. By the same token, the line interface unit 16 of the telephony device 10₁ would forward packets representing outbound data for the external data communications device 11₁ to central processing unit 24 for processing and transmission to the wireless data port 26 of FIG. 1.

As described, the telephony device 10₁ of FIG. 1 includes a wireless data communications port 26 that communicates information via infrared beams with the data communications port 14 in the external data communications device 11₁. Rather than utilize infrared beams, wireless data communications between the telephony device 10₁ and the external data communications device 11₁ could occur using radio frequency waves, typically in the megahertz or even gigahertz band. To that end, wireless data communication between the telephony device 10₁ and the external data communications device 11₁ (as well as between the telephony device 10₂ and the external data communications device 11₂) could occur using the “Bluetooth” radio frequency communications protocol or other suitable protocols.

Although the telephony device 10₁ of FIG. 1 is depicted as having a wired connection to the PSTN 12, such need not be the case. Indeed, the line interface circuit 16 could include a transceiver (not shown) to allow the telephony device to act as a wireless telephone for communicating with a wireless telephone network. The telephony device 10₁ could also take the form of a cordless telephone by providing a wireless connection between the handset 20 and the signal multiplexer and modem 22. Additionally, the telephony device 10₁ could include an audio amplifier and speaker (not shown) to afford the device the capability of acting as a speakerphone. Further, the telephony device 10₁ could include a record/playback mechanism (not shown) for allowing the device to also function as a telephone answering machine.

FIG. 2 illustrates a second embodiment of a telephony device 10′₁ in accordance with present principles for communicating information to and from an external data communications device 11₁ during a telephone call with another telephony device (not shown). The telephony device 10′₁ of FIG. 2 shares several elements in common with the telephony device 10₁ and like numerals have been used in FIG. 2 to reference like elements. Like the telephony device 10₁ of FIG. 1, the telephony device 10′₁ of FIG. 2 includes a central processing unit 24, a wireless data communications port 26, and a signal multiplexer and modem 22. Just like the signal multiplexer and modem 22 within the telephony device 10₁ of FIG. 1, the signal multiplexer and modem 22 within the telephony device 10′₁ of FIG. 2 serves to multiplex data received from the external data communications device 11₁ onto the call audio for transmission to the PSTN 12 via a line interface circuit 16₁. Likewise, the signal multiplexer and modem 22 within the telephony device 10′₁ serves to de-multiplex data off the call audio received at the line interface circuit 16 for processing by the central processing unit 24 and transmission via the wireless data communications port 26 to the external data communications device 11₁.

Unlike the telephony device 10₁ of FIG. 1 which includes a handset 20 and a keypad 18, thus allowing it to function as a stand alone telephone terminal, the telephony device 10′₁ of FIG. 2 lacks such elements. Instead, the telephony device 10′₁ includes a second line interface circuit 16₂ for connecting a conventional telephone set 28. For that reason, the telephony device 10′₁ can be thought of as an adjunct to the telephone set 28 because the telephone set 28, rather than the adjunct telephone device 10′₁, serves to initiate (set-up) a telephone call. Like the telephony device 10₁, the telephony device 10′₁ could a record/playback mechanism (not shown) for allowing the device to also function as a telephone answering machine. Further, the telephony device 10′₁ could include a speaker amplifier for allowing the device to function as a speaker phone.

FIG. 3 illustrates a third embodiment of a telephony device 10″₁ in accordance with the present principles. The telephony device 10″₁ serves as an adjunct to a separate telephone set 28 much like the telephony device 10′₁ of FIG. 2 and therefore like numerals have been used in FIG. 3 as in FIG. 2 to describe like elements. Unlike the telephony device 10″₁ of FIG. 2, the telephony device 10″₁ of FIG. 3 includes a single line interface circuit 16 arranged between the PSTN 12 and the signal multiplexer and modem 22 similar to the arrangement depicted in FIG. 1. Unlike the telephony device 10′₁ of FIG. 2, which possesses the second line interface circuit 16₁, the telephony device 10″₁ of FIG. 3 includes a switch 30, typically, a double-pole single throw switch, for connecting the tip and ring line of the telephone set 28 to the tip and ring lines, respectively, leading to the interface circuit 16.

During intervals of transfer of data between the telephony device 10″₁ and the external data communications device 11₁ (both of FIG. 3), the switch 30 remains “open” thereby disconnecting the telephone set 28 from the network 12. During other intervals, the switch 30 will remain closed, thereby keeping the telephone set 28 connected to the network 12, thereby allowing a user to launch and receive calls. Like the telephony device 10′₁, the telephony device 10″₁ could include a record/playback mechanism (not shown) for allowing the device to also function as a telephone answering machine. Further, the telephony device 10″₁ could include a speaker amplifier for allowing the device to function as a speaker phone.

The foregoing describes a system and method for communicating data to and from an external data communications device, such as a laptop computer or Personal Data Assistance over a wireless link simultaneously with a telephone call carried by a telephony device.

It is to be understood that the above-described embodiments are merely illustrative of the principles of the invention. Those skilled in the art can make various modifications and changes that will embody the principles of the invention and fall within the spirit and scope thereof.

1. A telephony device for communicating data between a communications network and an external data communications device during a telephone call carried by the telephony device, comprising:
an interface circuit for interfacing the telephony device to the communications network;
a wireless data communications port for communicating data to and from the external communications device across a wireless link; and
a control unit coupled to the wireless communications port for processing data received from the external communications device and sending such data to the interface circuit for transmission to the communications network during the telephone call and for processing data received from the communications network via the interface circuit for transmission to the external data communications device via the wireless data communications port during the telephone call.

2. The telephony device according to claim 1 wherein the control unit comprises:
a signal multiplexer and modem coupled to the interface circuit for de-multiplexing data received on a call audio portion of the telephone call and destined for the external data communications device and for multiplexing data from the external communications device onto the call audio of the telephone call; and
a central processing unit for processing the data de-multiplexed by the signal multiplexer and modem for transmission via the wireless data communications port to the external data communications device and for processing data received via the wireless data communications port from the external data communications device for transmission to the signal multiplexer and modem.

3. The telephony device according to claim 2 further including:
a telephone handset coupled to the signal multiplexer and modem for transmitting and receiving the call audio associated with the telephone call carried by the telephony device; and
a keypad coupled to the central processing unit for generating Dual Tone Multi-Frequency signals to set up the telephone call.

4. The telephony device according to claim 1 wherein the interface circuit provides a tip-ring connection to the communications network.

5. The telephony device according to claim 1 wherein the interface circuit de-packetizes digital information received from, and packetizes digital information for transmission to the communications network.

6. The telephony device according to claim 1 further including a connection mechanism for connecting an external telephone set to the telephony device.

7. The telephony device according to claim 1 wherein the connection mechanism includes a second interface circuit.

8. The telephony device according to claim 1 wherein the connection mechanism comprises a switch for selectively connecting the external telephone set to the interface circuit.

9. The telephony device according to claim 1 wherein the wireless data communications port communicates comprises an infrared data port.

10. The telephony device according to claim 1 wherein the wireless data communications port comprises a radio frequency data port.

11. The telephony device according to claim 2 wherein the signal multiplexer and modem mutes the call audio portion of the telephone call carried by the telephony device while data communication occurs between the external data communications device and the communications network.

12. The telephony device according to claim 2 wherein the signal multiplexer and modem multiplexes the data received from, and de-multiplexes data destined for the external data communications only during gaps in silence in the call audio portion of the telephone call.

13. The telephony device according to claim 2 wherein the signal multiplexer and modem multiplexes the data onto, and de-multiplexes data off the telephone call within a frequency band separate from the call audio portion so that simultaneous voice and data communications can occur.

14. The telephony device according to claim 2 wherein the signal multiplexer and modem multiplexes data onto and de-multiplexes data off of the call audio portion at a reduced amplitude so that a modem carrier signal is audible within the call audio portion.

15. The telephony device according to claim 2 wherein the signal multiplexer and modem multiplexes data onto and de-multiplexes off of the call audio portion a reduced amplitude so that a modem carrier signal is audible within the call audio portion and wherein an audible signal with an inverted carrier is applied to the call audio portion to substantially eliminate audible data signals.

16. A telephony device for communicating data between a communications network and an external data communications device during a telephone call carried by the telephony device, comprising:
an interface circuit for interfacing the telephony device to the communications network to enable the device to carry a telephone call;
a wireless data communications port for communicating data to and from the external communications device across a wireless link;
a signal multiplexer and modem coupled to the interface circuit for de-multiplexing data received on call audio portion of the telephone call, said data destined for the external data communications device and for multiplexing data from the external communications device onto the call audio portion of the telephone call; and
a central processing unit for processing the data de-multiplexed by the signal multiplexer and modem for transmission via the wireless data communications port to the external data communications device and for processing data received via the wireless data communications port from the external data communications device for transmission to the signal multiplexer and modem.

17. A telephony device for communicating data between a communications network and an external data communications device during a telephone call carried by the telephony device, comprising:
an interface circuit for interfacing the telephony device to the communications network to enable the device to carry a telephone call;
a wireless data communications port for communicating data to and from the external communications device across a wireless link;
a signal multiplexer and modem coupled to the interface circuit for de-multiplexing data received on call audio portion of the telephone call, said data destined for the external data communications device and for multiplexing data from the external communications device onto the call audio portion of the telephone call;
a central processing unit for processing the data de-multiplexed by the signal multiplexer and modem for transmission via the wireless data communications port to the external data communications device and for processing data received via the wireless data communications port from the external data communications device for transmission to the signal multiplexer and modem;
a telephone handset coupled to the signal multiplexer and modem for transmitting and receiving the call audio portion associated with the telephone call carried by the telephony device; and
a keypad coupled to the interface circuit for generating Dual Tone Multi-Frequency signals to set up the telephone call.

18. A telephony device for communicating data between a communications network and an external data communications device during a telephone call carried by the telephony device, comprising:
an interface circuit for interfacing the telephony device to the communications network to enable the device to carry a telephone call;
a wireless data communications port for communicating data to and from the external communications device across a wireless link;
a signal multiplexer and modem coupled to the interface circuit for de-multiplexing data received on call audio portion of the telephone call, said data destined for the external data communications device and for multiplexing data from the external communications device onto the call audio portion of the telephone call;
a central processing unit for processing the data de-multiplexed by the signal multiplexer and modem for transmission via the wireless data communications port to the external data communications device and for processing data received via the wireless data communications port from the external data communications device for transmission to the signal multiplexer and modem; and
a connection mechanism for connecting an external telephone set to the telephony device.

19. A method for communicating data between a communications network and an external data communications device during a telephone call, comprising the steps of:
establishing the telephone call with the network to send and receive call audio;
receiving, via a wireless link, outbound data from an external data communications device destined for the network
multiplexing the outbound data from the external device onto the call audio for transmission to the network;
de-multiplexing inbound data from the network off the call audio; and
transmitting the inbound data via the wireless link to the external data communications device.

20. The method according to claim 18 wherein the receiving and transmitting steps comprise receiving and transmitting, respectively, a infrared beam.

21. The method according to claim 18 wherein the receiving and transmitting steps comprise receiving and transmitting, respectively, radio frequency signals.

22. The method according to claim 18 wherein the call audio of the telephone call is muted while data communication occurs between the external data communications device and the communications network.

23. The method according to claim 18 wherein the data is multiplexed onto and de-multiplexed off the call audio only during gaps of silence therein.

24. The method according to claim 18 wherein data is multiplexed onto and de-multiplexed off the call audio within a frequency band separate from the call audio so that simultaneous voice and data communications can occur.

25. The method according to claim 18 wherein data is multiplexed onto and de-multiplexed off the call audio portion at a reduced amplitude so that a modem carrier signal is audible within the call audio.

26. The method according to claim 18 wherein data is multiplexed onto and de-multiplexed from the call audio portion within a frequency band corresponding to the call audio portion but at a reduced amplitude so that a modem carrier signal is audible within the call audio portion further including the step of applying an audible signal with a inverted carrier to substantially eliminate audible data signals.
